(19) United States
(12) Patent Application Publication
(10) Pub. No.: US 2017/0054233 A1
(43) Pub. Date: Feb. 23, 2017

(54) CIRCUIT BOARD CONNECTOR AND CIRCUIT BOARD

(71) Applicant: Sumitomo Wiring Systems, Ltd., Yokkaichi (JP)

(72) Inventor: Takahiro Kikuchi, Yokkaichi (JP)

(21) Appl. No.: 15/226,348

(22) Filed: Aug. 2, 2016

(30) Foreign Application Priority Data
Aug. 19, 2015 (JP) 2015-161743

(51) Int. Cl. H01R 12/70; H01R 12/71; H01R 13/405; H01R 43/048

(52) U.S. Cl. CPC H01R 12/7064; H01R 43/0484; H01R 12/7082; H01R 12/716; H01R 13/405

(57) ABSTRACT

A circuit board connector (1) includes terminal groups (4) in which a plurality of terminals (10) are arranged. A downward extending portion (16) of the terminal (10) constituting the terminal group (4) is formed with a press-fit portion (20) to be press-fit into a mounting hole (102) of a circuit board (100). Receiving portions (31, 32) projecting in a direction intersecting with a press-fitting direction are respectively formed on outer edge parts (12A, 12B) on opposite sides in an arrangement direction on a side behind the press-fit portion (20) in the press-fitting direction. The receiving portions of each terminal (10) are located at positions different in the press-fitting direction, and the receiving portions respectively formed on the outer edge parts facing each other are located at positions different in the press-fitting direction between adjacent terminals adjacent in the arrangement direction.

### BACKGROUND

1. Field of the Invention

The invention relates to a circuit board connector and a circuit board provided therewith.

2. Description of the Related Art

Japanese Unexamined Patent Publication No. 2004-178992 shows a conventionally available press-fit terminal to be inserted into a through hole formed on a circuit board and electrically connected to the circuit board by a resilient force. In this technique, the press-fit terminals provided side by side in a connector housing are coupled to the circuit board by a terminal press-fitting tool.

In the case of press-fitting terminals of a press-fit structure into through holes formed on a circuit board, the terminals need to be pushed into while being pressed by a tool. In the technique of Japanese Unexamined Patent Publication No. 2004-178992, receiving portions protruding toward left and right sides of the terminal are provided and the terminal is pushed into the through hole by pushing the receiving portions by the tool during press-fitting. However, if the receiving portions are provided to protrude from the opposite sides as in Japanese Unexamined Patent Publication No. 2004-178992, the receiving portions of the adjacent terminals face each other and a distance (pitch) between the terminals has to be extended by that much.

On the other hand, a technique intended to narrow a distance (pitch) between terminals in a connector in which the terminals of a press-fit structure are provided side by side is disclosed in Japanese Unexamined Patent Publication No. 2004-241193. In this technique, a plurality of terminals provided side by side include the terminals having receiving portions arranged at a low position and those having the receiving portions arranged at a high position, two types of the terminals being alternately provided. By this configuration, the vertical positions of the receiving portions are made different between the adjacent terminals, thereby preventing the mutual interference of the receiving portions between the adjacent terminals.

However, the technique of Japanese Unexamined Patent Publication No. 2004-241193 requires the terminals having the receiving portions arranged at the low position and those having the receiving portions arranged at the high position, i.e. requires two types of the terminals largely different in shape. In such a configuration essentially including a plurality of types of terminals largely different in shape in this way, manufacturing burdens due to an increase in the number of types of terminals is unavoidable.

The present invention was developed based on the above situation and aims to realize a configuration capable of improving overall operability.

### SUMMARY

Overall operability is improved particularly by preventing the mutual interference of receiving portions between adjacent terminals with outer edge shapes of the adjacent terminals approximated in a circuit board connector in which terminals of a press-fit structure are arranged.

The invention relates to a circuit board connector comprising a housing and terminals. Each rminal includes a press-fit portion to be press-fit into a mounting hole of a circuit board and an extending portion extending in a specified direction. The terminal includes receiving portions projecting in a direction intersecting with a press-fitting direction on outer edge parts on substantially opposite sides in an arrangement direction intersecting with the specified direction on a side behind the press-fit portion in the press-fitting direction. The receiving portion is provided on one side in the arrangement direction and the receiving portion provided on the other side in the arrangement direction are located at positions different in the press-fitting direction.

The receiving portions formed on the outer edge parts facing each other may be located at positions different in the press-fitting direction between adjacent terminals adjacent in the arrangement direction.

The press-fit portion of the terminal may be inserted through the housing.

The respective receiving portions of the terminal provided on the opposite sides in the arrangement direction may project in the arrangement direction. In the case of this configuration, when a tool is inserted between the adjacent terminals, this tool is more likely to satisfactorily act on each receiving portion projecting in the arrangement direction. That is, in the case where the respective receiving portions project in the arrangement direction, a tool having a tip shape in conformity with the respective receiving portions between the adjacent terminals is configured and this tool is less likely to be separated from the respective receiving portions and more likely to reliably act to push the respective receiving portions when being inserted between the adjacent terminals.

An inclined portion located more backward in the press-fitting direction toward a tip side of the receiving portion in a projecting direction may be formed on a rear end part of the receiving portion of the terminal in the press-fitting direction. In the case where the inclined portion is provided on the rear end part of the receiving portion in the press-fitting direction, the tool pushing the receiving portion is easily guided to a base end side of the receiving portion in the press-fitting direction when the receiving portion is pushed from the rear side in the press-fitting direction by the tool to press-fit the terminal into the circuit board. Thus, a situation where the tool pushing the receiving portion slips toward the tip side and is separated from the receiving portion can be made less likely to occur and the terminal can be more reliably pushed into.

A recess recessed substantially in the arrangement direction may be formed on or at a boundary part between a rear end part of the receiving portion and a side part on the outer edge part.

A distance along the press-fitting direction between a front end part of the receiving portion formed on one outer edge part of the terminal and a rear end part of the receiving portion formed on the other outer edge part of the adjacent terminal may be larger than 0, and/or a lateral distance between a projecting end part of the receiving portion formed on one outer edge part of the terminal and a projecting end part of the receiving portion formed on an other outer edge part of the adjacent terminal may be larger than 0.

According to another aspect, there is provided a circuit board equipped with the above-described circuit board connector. The circuit board may comprise mounting holes and the circuit board connector may have terminals each including a press-fit portion.

Accordingly, the receiving portions formed on the outer edge parts facing each other are located at the positions different in the press-fitting direction between the adjacent terminals adjacent in the arrangement direction out of the plurality of terminals arranged side by side in the arrangement direction. Thus, the mutual interference of the receiving portions between the adjacent terminals can be prevented and an increase of an inter-terminal distance due to the interference of the receiving portions can be suppressed. In addition, any of the plurality of terminals arranged in the arrangement direction has a common shape in the vicinity of the receiving portions by locating the receiving portion provided on the one side in the arrangement direction and the receiving portion provided on the other side in the arrangement direction at the positions different in the press-fitting direction. Thus, a configuration capable of preventing the mutual interference of the receiving portions between the adjacent terminals can be realized with the outer edge shapes of the adjacent terminals approximated.

### BRIEF DESCRIPTION OF THE DRAWINGS

FIG. 1 is a rear view of a circuit board connector according to an embodiment.

FIG. 2 is a side view in section of the circuit board connector of FIG. 1.

FIG. 3 is a partial section showing a state before terminals of the circuit board connector of FIG. 1 are press-fitted into through holes of a circuit board.

FIG. 4 is an enlarged view enlargedly showing a part of FIG. 3.

FIG. 5 is an enlarged view enlargedly showing a part of FIG. 4.

FIG. 6 is an enlarged view showing an example of a circuit board connector according to another embodiment.

FIG. 7 is an enlarged view showing another example of the circuit board connector according to the other embodiment.

### DETAILED DESCRIPTION

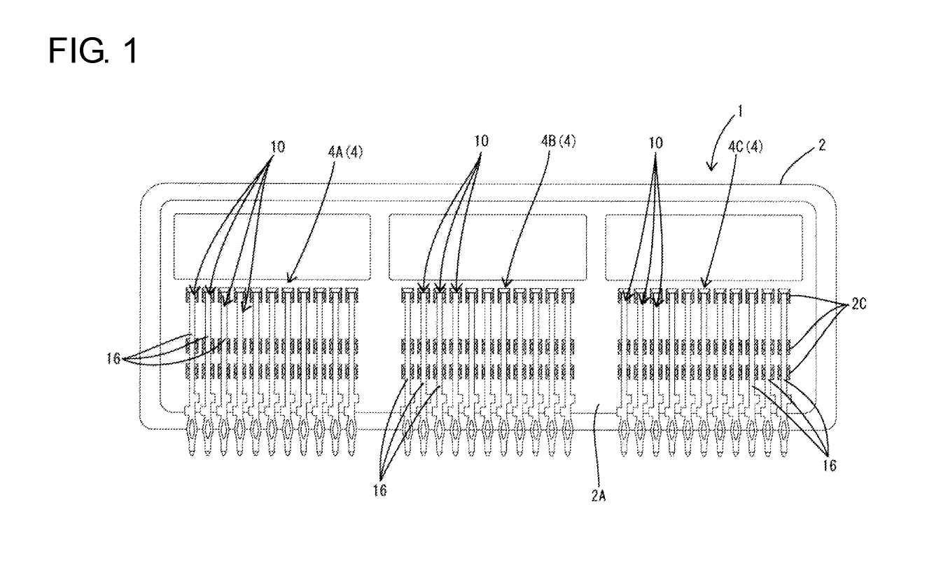

Hereinafter, an embodiment is described with reference to FIGS. 1 to 5.

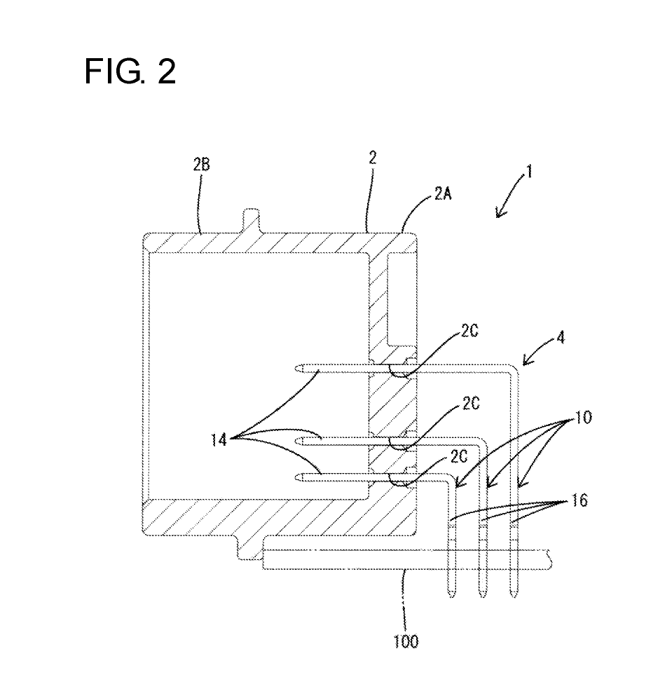

A circuit board connector 1 (hereinafter, also merely referred to as a connector 1) illustrated in FIGS. 1 to 5 is configured, for example, as a vehicle-mounted connector to be connected to a vehicle-mounted circuit board. As shown in FIGS. 1 and 2, this connector 1 mainly includes a housing 2 made of synthetic resin and a plurality of terminals 10 to be mounted by being at least partly inserted through or into the housing 2.

In the following description, a lateral direction of FIGS. 1, 3 and 4 is referred to as a lateral direction of the connector 1. Further, a vertical direction is based on FIGS. 1 to 4. Further, a lateral direction of FIG. 2 is referred to as a front-back direction and a mating side with a (unillustrated) mating connector (a left side of FIG. 2) is referred to as a front side of the connector 1.

The housing 2 has a main body portion 2A formed to be long in the lateral direction as shown in FIG. 1, and a receptacle 2B fittable to an unillustrated mating connector housing is formed in front of the main body portion 2A as shown in FIG. 2. The main body portion 2A is configured as a wall portion vertically standing up or projecting and/or substantially extending in the lateral direction and formed with through holes 2C penetrating substantially in the front-back direction. As shown in FIGS. 1 and 2, the main body portion 2A is formed with one or more (e.g. three) hole rows, in which the through holes 2C are arranged in the lateral direction, in the vertical direction (one or more, e.g. three, stages).

The terminal 10 is configured as a press-fit terminal and/or formed into a long and narrow (substantially rectangular or polygonal) wire shape as a whole by pressing a metal wire excellent in electrical conductivity. The terminal 10 substantially is, for example, bent or L-shaped as shown in FIG. 2 and a mounting portion 14 is formed as a substantially straight part on one end side. Further, a bent or downward extending portion 16 is formed as a substantially straight part on the other end side.

As shown in FIG. 2, each terminal 10 is mounted in the housing 2 with the mounting portion 14 press-fitted in a press-fitting direction PFD in the through hole 2C from a back surface side and arranged in a state where a part of the mounting portion 14 and the downward extending portion 16 extend down or in the press-fitting direction PFD from the back surface side of the housing 2. The mounting portion 14 of each terminal 10 projects into the receptacle 2B from the front surface of the main body portion 2A and functions to come into contact with a mating terminal provided in an unillustrated mating housing when the receptacle 2B is connected to this mating housing.

The downward extending portion 16 is coupled to an end part of the mounting portion 14 as shown in FIG. 2, and extends downward or in the press-fitting direction PFD substantially along the vertical direction from this end part. Note that the downward extending portion 16 corresponds to an example of an extending portion and the vertical direction as an extending direction of the downward extending portion 16 corresponds to an example of a predetermined direction.

As shown in FIG. 1, the connector 1 is provided with a plurality of terminal groups 4 in which a plurality of terminals 10 are arranged. In each terminal group 4, the downward extending portions 16 of the plurality of terminals 10 constituting the terminal group 4 are arranged substantially side by side in the lateral direction (arrangement direction AD). Note that although only some terminal groups 4A, 4B and 4C out of a plurality of terminal groups 4 provided in the connector 1 are shown in FIG. 1, one or more, e.g. two terminal groups are provided in front of each of the terminal groups 4A, 4B and 4C.

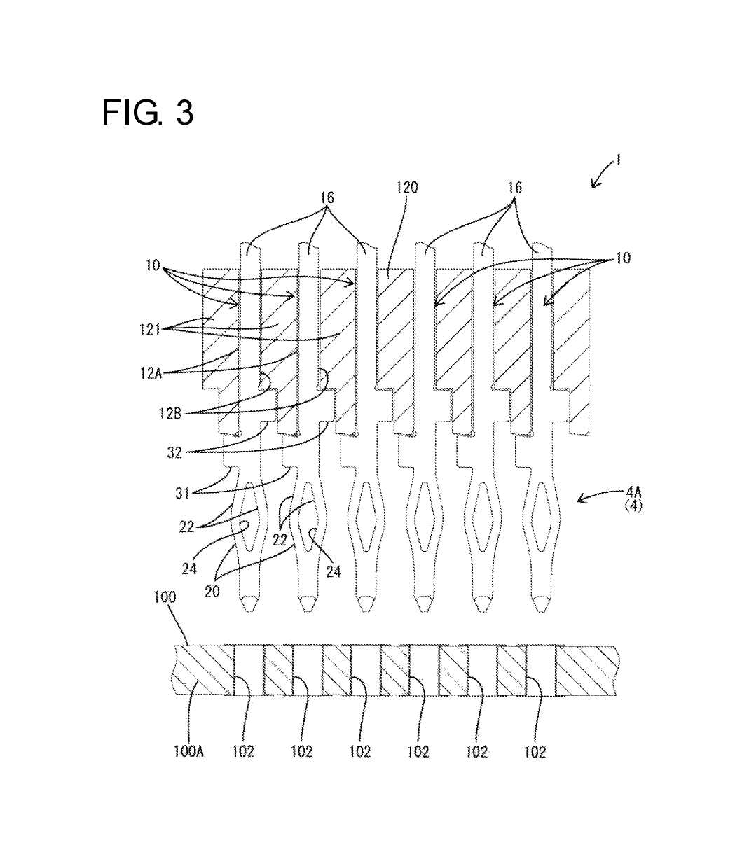

One terminal group 4A is focused and described below mainly with reference to FIGS. 3 to 5. Note that although the terminal group 4A shown in FIG. 1 is described with reference to FIGS. 1 to 5, the terminal groups 4B and 4C are similarly configured to the terminal group 4A and the unillustrated terminal groups other than these are also similarly configured to the terminal group 4A.

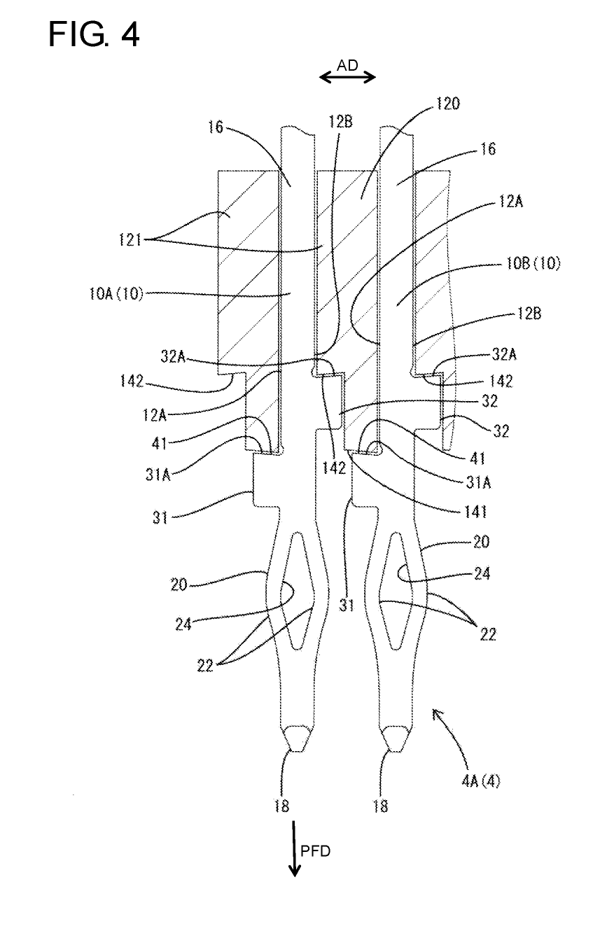

As shown in FIG. 3, the plurality of terminals 10 constituting or forming part of the terminal group 4A have the downward extending portions 16 shaped substantially identically. As shown in FIG. 4, a tapered portion 18 is formed on or at a tip part of the downward extending portion 16, and a press-fit portion 20 to be press-fitted in the press-fitting direction PFD into a mounting hole 102 of a circuit board 100 is formed above (rear side in the press-fitting direction PFD) the tapered portion 18 on a tip side of the downward extending portion 16. The downward extending portion 16 including this press-fit portion 20 is configured to vertically extend.

Note that each terminal 10 of the connector 1 is press-fitted into the mounting hole 102 to be described later with the press-fitting direction PFD or the vertical direction, in which the downward extending portion 16 of each terminal 10 extends, as the press-fitting direction PFD. That is, the vertical direction is the press-fitting direction PFD of the terminal 10 in the connector 1. In the description of this specification, the tip side (i.e. lower side) of the downward extending portion 16 is a front side in the press-fitting direction PFD and a base end side (i.e. upper side) of the downward extending portion 16 is a rear side in the press-fitting direction PFD.

As shown in FIG. 3, the press-fit portion 20 includes two resilient contact portions 22. The resilient contact portion(s) 22 is/are, for example, in the form of thick strip(s) and formed to substantially arcuately bulge out toward outer lateral sides with a groove portion 24 therebetween. As shown in FIG. 3, before the press-fit portion 20 is inserted into the mounting hole 102, a maximum width of the both resilient contact portions 22 in a radial direction (lateral direction or a direction intersecting with the press-fitting direction PFD) is set to be larger than an inner diameter of an inner peripheral part (contact portion) of the mounting hole 102 by a specified amount. When the press-fit portion 20 is inserted into the mounting hole 102, the resilient contact portions 22 are resiliently deformed to be pressed and contracted in the radial direction (lateral direction) and come into contact with the inner peripheral part (contact portion) of the mounting hole 102 while generating a resilient restoring force. By such a contact, the terminal 10 is electrically connected to the inner peripheral part (contact portion) of the mounting hole 102.

As shown in FIG. 4, the terminal 10 constituting or forming part of the terminal group 4A is formed with receiving portions 31, 32 thyat function as tool placing portions, on outer edge parts 12A, 12B on substantially opposite sides in the arrangement direction AD (lateral direction) on a side behind the press-fit portion 20 in the press-fitting direction PFD (upper side). These receiving portions 31, 32 are respectively formed to project in a direction intersecting with the press-fitting direction PFD (specifically, lateral direction corresponding to the arrangement direction AD). The receiving portion 31 is formed to project toward one side in the arrangement direction on the outer edge part 12A provided on one side of the terminal 10 in the arrangement direction AD in the terminal group 4A. The receiving portion 32 is formed to project substantially toward the other side in the arrangement direction AD on the outer edge part 12B provided on the other side of the terminal 10 in the arrangement direction AD in the terminal group 4A. On each terminal 10, the receiving portion 31 provided on the one side in the arrangement direction AD and the receiving portion 32 provided on the other side in the arrangement direction AD are located at positions different or offset in or along the press-fitting direction PFD. Specifically, a lower end part of the receiving portion 32 formed at an upper position is located above an upper end part of the receiving portion 31 formed at a lower position.

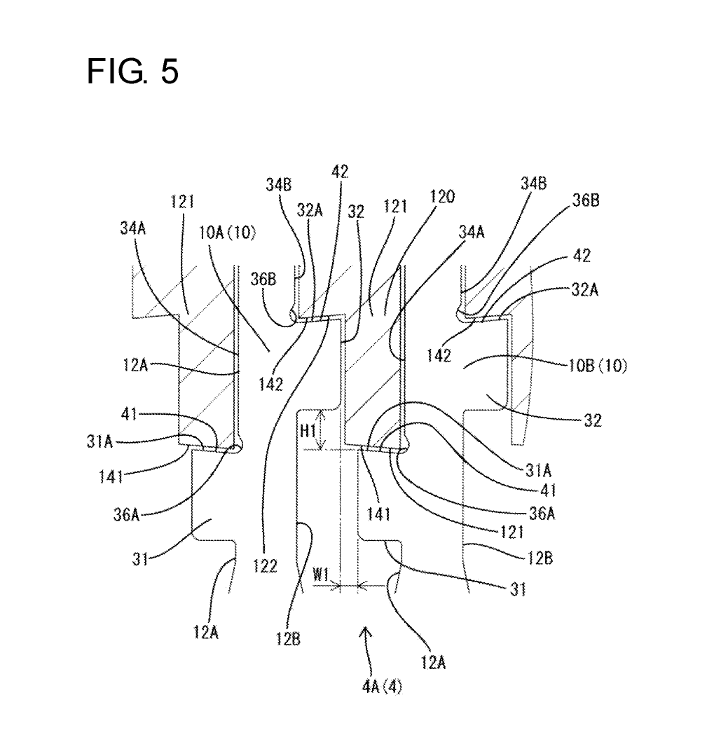

As shown in FIG. 5, the receiving portions 31, 32 formed on each terminal 10 constituting or forming part of the terminal group 4A substantially are both in the form of a substantially rectangular flat plate. End parts 31A, 32A on the rear sides (upper sides) of the respective receiving portions 31, 32 in the press-fitting direction PFD serve as contact edges with which a terminal press-fitting tool 120 to be described later is to be brought into contact. The end part 31A on the rear side of the receiving portion 31 in the press-fitting direction PFD is formed with an inclined portion 41 located more backward in the press-fitting direction PFD (i.e. more upward) toward a tip side of the receiving portion 31 in the projecting direction. In the configuration of FIG. 5, the substantially entire end part 31A on the rear side of the receiving portion 31 in the press-fitting direction serves as the inclined portion 41, and/or the upper end surface of the receiving portion 31 is formed into an inclined surface located higher with distance from a lateral center position of the terminal 10. The end part 32A on the rear side of the receiving portion 32 in the press-fitting direction PFD is formed with an inclined portion 42 located more backward (i.e. more upward) in the press-fitting direction PFD toward a tip side of the receiving portion 32 in the projecting direction. In the configuration of FIG. 5, the substantially entire end part 32A on the rear side of the receiving portion 32 in the press-fitting direction PFD serves as the inclined portion 42, and the upper end surface of the receiving portion 32 is formed into an inclined surface located higher with distance from the lateral center position of the terminal 10.

Further, a recess 36A recessed toward the center side (lateral center side) of the terminal 10 in the arrangement direction AD is formed on a boundary between the rear end part 31A of the receiving portion 31 and a side part 34A above this end part 31A on the outer edge part 12A on the one side of the terminal 10 in the arrangement direction AD. A recess 36B recessed toward the center side (lateral center side) of the terminal 10 in the arrangement direction AD is formed on a boundary part between the rear end part 32B of the receiving portion 32 and a side part 34B above this end part 32B on the outer edge part 12B provided on the other side of the terminal 10 in the arrangement direction AD.

In such a terminal group 4A in which the terminals 10 are arranged in the arrangement direction AD (lateral direction), the receiving portions formed on the respective outer edge parts facing each other are located at different positions in the press-fitting direction PFD between the adjacent terminals adjacent in the arrangement direction AD as shown in FIG. 3. For example, two terminals 10A, 10B constituting a part of the terminal group 4A are focused and shown in FIGS. 4 and 5. On these terminals 10A, 10B, the outer edge part 12B of the terminal 10A and the outer edge part 12A of the terminal 10B face each other, and the receiving portion 32 formed on the outer edge part 12B of the terminal 10A and the receiving portion 31 formed on the outer edge part 12A of the adjacent terminal 10B are located at positions different in the press-fitting direction PFD and arranged while being vertically shifted.

Specifically, as shown in FIG. 5, a vertical distance H1 between a lower end part of the receiving portion 32 formed on the outer edge part 12B of the terminal 10A and an upper end part of the receiving portion 31 formed on the outer edge part 12A of the terminal 10B is larger than 0. Further, a lateral distance W1 between a projecting end part (lateral end part) of the receiving portion 32 formed on the outer edge part 12B of the terminal 10A and a projecting end part (lateral end part) of the receiving portion 31 formed on the outer edge part 12A of the terminal 10B is larger than 0.

The connector 1 thus configured is used by connecting the aforementioned terminals 10 (press-fit terminals) to the circuit board 100 as shown in FIG. 3. As shown in FIG. 3, the circuit board 100 is configured as a multilayer board formed with a multitude of mounting holes 102. The mounting hole 102 is, for example, configured as a known through hole and formed to penetrate between a board surface on one side of a board main body 100A made of an insulating material and a board surface on the other side. A conductive layer such as Cu plating is arranged on the inner peripheral part of the mounting hole 102 and configured as a contact portion having electrical conductivity. The conductive layer on the inner peripheral part of the mounting hole 102 is connected to one or more wiring layers or busbars arranged, for example, on a surface of and/or in the board main body 100A and are electrically conductive with these. Note that the wiring layers formed on and/or in the circuit board 100, mounted components and the like are not shown in FIG. 3.

Next, an example of the procedure of mounting the connector 1 on the circuit board 100 is described.

The aforementioned connector 1 is to be mounted on the circuit board 10 using the terminal press-fitting tool 120 as shown in FIG. 3. The terminal press-fitting tool 120 has a comb-like shape in which long and narrow pressing portions 121 are arranged at a fixed interval, and a tip part of each pressing portion 121 has a stepped shape in conformity with the positions of the both end parts 31A, 32A of the receiving portions 31, 32 proximate between the terminals. Note that a plurality of pressing portions 121 may be integrally or unitarily formed or may be coupled by a separate member.

Specifically, as shown in FIG. 4, a first pressing portion 141 for pressing the receiving portion 31 at the lower position and a second pressing portion 142 for pressing the receiving portion 32 at the upper position are formed on the tip part of the pressing portion 121 and, when the pressing portion 121 at least partly is inserted between the terminals and the tip part thereof is brought closer to the receiving portions 31, 32 as shown in FIG. 4, the first and second receiving portions 141, 142 respectively come into contact with the end parts 31A, 32A of the proximate receiving portions 31, 32.

In the case of mounting the connector 1 on the circuit board 100, the connector 1 is held by an unillustrated setting device and arranged to be vertically movable in such a posture that the downward extending portions 16 extend downward (or along the press-fitting direction PFD). Further, in the setting device, the circuit board 100 is fixed in a horizontal posture below the connector 1 as shown in FIG. 3 and the downward extending portion 16 of each terminal 10 is arranged to substantially be located right above the corresponding mounting hole 102 of the circuit board 100.

Then, the aforementioned terminal press-fitting tool 120 is inserted from above the connector 1 held in the setting device and the first and second pressing portions 141, 142 formed on each pressing portion 121 of the terminal press-fitting tool 120 are respectively brought into contact with the end parts 31A, 32A of the receiving portions 31, 32 provided between the terminals as shown in FIG. 4. Subsequently, the receiving portions 31, 32 are pressed down (or in the press-fitting direction PFD) toward the circuit board 100 by each or the respective pressing portion 121 and the resilient contact portions 22 of the downward extending portion 16 at least partly are press-fitted into the mounting hole 102. When being inserted into the mounting hole 102 by a specified amount, the resilient contact portions 22 are locked in the mounting hole 102 by their resilient forces substantially acting in the radial direction and electrically connected to the inner peripheral part (contact portion) of the mounting hole 102.

As described above, in the terminal group 4 provided in the aforementioned circuit board connector 1, the receiving portions formed on the respective outer edge parts facing each other are located at the positions different in the press-fitting direction PFD between the adjacent terminals adjacent in the lateral direction (predetermined arrangement direction). Thus, the mutual interference of the receiving portions between the adjacent terminals can be prevented and an increase of an inter-terminal distance due to the interference of the receiving portions can be suppressed. In addition, any of the plurality of terminals 10 arranged in the arrangement direction AD (lateral direction) in the terminal group 4 is shaped such that the receiving portion 31 provided on the one side in or along the arrangement direction AD and the receiving portion 32 provided on the other side in or along the arrangement direction AD are located at the positions different in the press-fitting direction PFD and has a common shape near the receiving portions 31. Thus, a configuration capable of preventing the mutual interference of the receiving portions 31 between the adjacent terminals can be realized with the outer edge shapes of the adjacent terminals 10 approximated.

For example, in the technique of Japanese Unexamined Patent Publication No. 2004-178992 described above, a plurality of types of terminals largely different in shape are mixed. Thus, there is a concern for rising mold cost and the like due to an increase of the types of the terminals. Further, in the case of forming terminals by punching by an automatic machine, it is necessary to separately punch a plurality of types of terminals. Thus, there is a concern for the complication of a facility, rising facility cost, an increase of a processing time and the like. In contrast, since the downward extending portions 16 can have a common shape in the terminal group 4 according to the connector 1 described above, these problems can be solved.

Further, the terminal 10 of the connector 1 is configured so that the respective receiving portions 31, 32 provided on the substantially opposite sides in or along the arrangement direction AD (or a direction intersecting with the press-fitting direction PFD) project in the arrangement direction AD (lateral direction). In the case of this configuration, when the tool (pressing portion 121) having a tip shape in conformity with or corresponding to the heights or positions of the receiving portions 31, 32 as shown in FIGS. 3 and 4 is inserted between the adjacent terminals, this pressing portion 121 is less likely to be separated from the respective receiving portions 31, 32 and likely to reliably press the respective receiving portions 31, 32, thus improving overall operability of the assembling process.

Further, in the connector 1, the end parts 31A, 32A on the rear sides of the respective receiving portions 31, 32 formed on each terminal 10 in the press-fitting direction PFD are respectively formed with the inclined portions 41, 42 configured to be located more backward or offset in or along the press-fitting direction PFD toward the tip sides of the receiving portions in the projecting directions. In the case of providing the above inclined portions 41, 42 on the end parts 31A, 32A on the rear sides of the receiving portions 31, 32 in the press-fitting direction PFD, the tool pushing the receiving portions 31, 32 is easily guided to the base end sides of the receiving portions 31, 32 in the projecting directions when the receiving portions 31, 32 are pushed by the tool from the rear side in the press-fitting direction PFD to press-fit the terminal 10 into the circuit board 100. Thus, a situation where the tool for pushing the receiving portions 31, 32 slips toward the tip sides to be separated from the receiving portions 31, 32 can be made less likely to occur, wherefore the terminal 10 can be more reliably pushed into.

Other embodiments are briefly described below.

Although both of the receiving portions 31, 32 provided on the opposite sides of the terminal 10 constituting each terminal group 4 in the lateral direction (arrangement direction AD) project in the lateral direction (arrangement direction AD) in the aforementioned embodiment, either one or both of the receiving portions may project in a direction oblique to the arrangement direction AD or in the front-back direction instead of projecting in the lateral direction (arrangement direction AD).

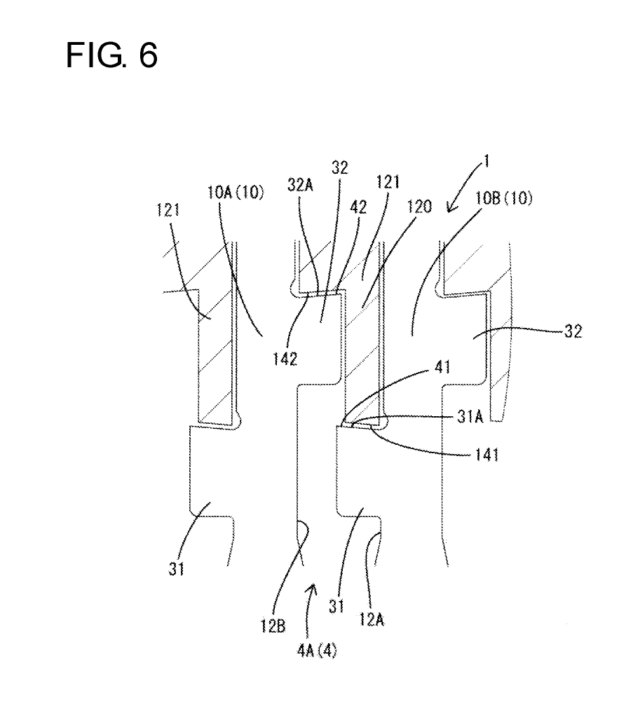

Although the lateral distance W1 between the projecting end part (lateral end part) of the receiving portion 32 formed on the outer edge part 12B of the terminal 10A and the projecting end part (lateral end part) of the receiving portion 31 formed on the outer edge part 12A of the terminal 10B is larger than 0 as shown in FIG. 5 in the above embodiment, this distance may be 0. Alternatively, the projecting end part (lateral end part) of the receiving portion 32 formed on the outer edge part 12B of the terminal 10A may be closer to the lateral center position of the terminal 10B than the projecting end part (lateral end part) of the receiving portion 31 formed on the outer edge part 12A of the terminal 10B as shown in FIG. 6. That is, the receiving portion 32 formed on the outer edge part 12B of the terminal 10A and the receiving portion 31 formed on the outer edge part 12A of the terminal 10B may overlap in the vertical direction (or along the press-fitting direction PDF) in a partial area. By doing so, the inter-terminal distance can be even shortened, and a narrower pitch can be more easily realized.

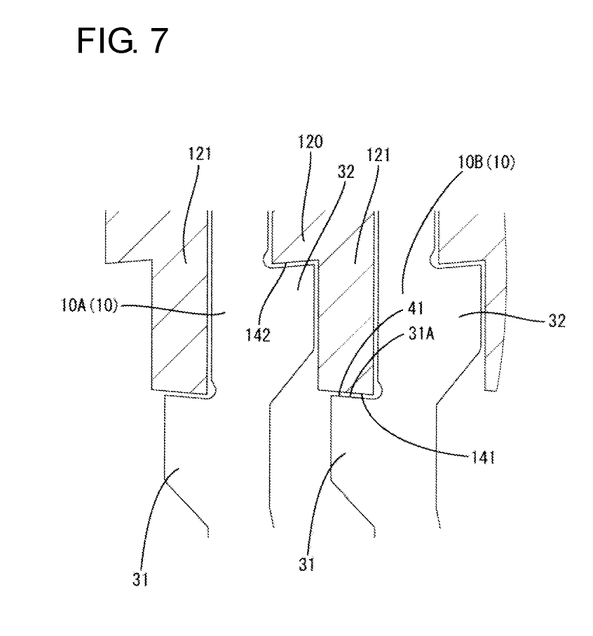

The shapes of lower end parts of the receiving portions 31, 32 shown in FIG. 5 may be changed as shown in FIG. 7. In an example of FIG. 7, the lower end parts (end parts on the front side in the press-fitting direction PFD) of the receiving portions 31, 32 provided on each terminal 10 are formed into inclined portions having such an inverse tapered shape as to be located more backward (upward) in the press-fitting direction PFD toward the tip sides of the receiving portions. Further, in the configuration of FIG. 7, the upper end part of the receiving portion 32 is located at a lower position (position on the front side in the press-fitting direction PFD) in the vertical direction than the upper end part of the receiving portion 31 between the adjacent terminals 10. By doing so, it is possible to effectively enhance the strength of the receiving portions while ensuring an insulation distance.

### LIST OF REFERENCE SIGNS

1 . . . circuit board connector

2 . . . housing

6A, 6B, 6C terminal row

10 . . . terminal

12A, 12B . . . outer edge part

16 . . . downward extending portion

20 . . . press-fit portion

31, 32 . . . receiving portion

31A, 32A . . . end part

41, 42 . . . inclined portion

100 . . . circuit board

102 . . . mounting hole

120 . . . tool

PFD . . . press-fitting direction

AD . . . arrangement direction

What is claimed is:

1. A circuit board connector (1), comprising:
a housing (2); and
terminals (10) each including a press-fit portion (20) to be press-fitted into a mounting hole (102) of a circuit board (100) and an extending portion (16) extending in a specified direction, wherein:
the terminal (10) includes receiving portions (31, 32) projecting in a direction intersecting with a press-fitting direction (PFD) on outer edge parts (12A, 12B) on substantially opposite sides in an arrangement direction (AD) intersecting with the specified direction on a side behind the press-fit portion (20) in the press-fitting direction (PFD); and
the receiving portion (31) on one side in the arrangement direction (AD) and the receiving portion (32) on the other side in the arrangement direction (AD) are at positions different in the press-fitting direction (PFD).

2. The circuit board connector of claim 1, wherein the receiving portions (31, 32) on the outer edge parts (12A, 12B) facing each other are at positions different in the press-fitting direction (PFD) between adjacent terminals (10) adjacent in the arrangement direction (AD) out of a plurality of the terminals (10) arranged substantially side by side in the arrangement direction (AD).

3. The circuit board connector of claim 1, wherein the press-fit portion (20) of the terminal (10) is to be inserted through the housing (2).

4. The circuit board of claim 1, wherein the respective receiving portions (31, 32) of the terminal (10) provided on the opposite sides in the arrangement direction (AD) project in the arrangement direction (AD).

5. The circuit board connector of claim 1, further comprising an inclined portion (41, 42) formed on a rear end part of the receiving portion (31, 32) of the terminal (10) in the press-fitting direction (PFD) and located more backward in the press-fitting direction (PFD) toward a tip side of the receiving portion (31, 32) in a projecting direction.

6. The circuit board connector of claim 1, further comprising a recess (36A) formed on or at a boundary part between a rear end part (31A) of the receiving portion (31) and a side part (34A) on the outer edge part (12A) and recessed substantially in the arrangement direction (AD).

7. The circuit board connector of claim 1, wherein a distance (H1) along the press-fitting direction (PFD) between a front part of the receiving portion (32) formed on one outer edge part (12B) of the terminal (10A) and a rear part of the receiving portion (31) formed on the other outer edge part (12A) of the adjacent terminal (10B) is larger than 0, and/or wherein a lateral distance (W1) between a projecting end part of the receiving portion (32) formed on one outer edge part (12B) of the terminal (10A) and a projecting end part of the receiving portion (31) formed on another outer edge part (12A) of the adjacent terminal (10B) is larger than 0.

8. A circuit board (100) formed with a plurality of mounting holes (102) and comprising the circuit board connector (1) of claim 1 with the press-fit portions (20) of the terminals (10) being press-fit into the mounting holes (102).
